(19) United States
(12) Patent Application Publication
(10) Pub. No.: US 2008/0295247 A1
(43) Pub. Date: Dec. 4, 2008

(54) ADJUSTABLE FRAME FOR BED COVER SUPPORT AND OTHER USES AND ADJUSTMENT SYSTEM FOR FRAMES

(76) Inventor: DUKE V. ROGERS, MERIDIAN, ID (US)

Correspondence Address: PEDERSEN & COMPANY, PLLC, P.O. BOX 2666, BOISE, ID, 83701, US

(21) Appl. No.: 12/122,909

(22) Filed: May 19, 2008

Related U.S. Application Data
(60) Provisional application No. 60/941,280, filed on May 31, 2007.

(51) Int. Cl. A47C 21/02; F16H 35/00

(52) U.S. Cl. 5/505.1; 74/841

(57) ABSTRACT

A lightweight, collapsible, portable, adjustable tubing structure is used upon any conventional bed to lift and support the bed covers above the desired portions of the anatomy of an occupant of the bed. The device may feature multiple adjustments, for example, vertical (height) adjustment and horizontal (width) adjustment. Preferably, all the adjustments are continuous, non-incremental adjustments to best fit the device to a given bed. The device may be made of simple and extremely durable off-the-shelf pieces, preferably of PVC pipe, bushings, tees, and elbows, plus adjustment system that comprise threaded mobs holding a nut and bolt pressure lock system. Other adjustment system may be used, such as pins, clips, fasteners, or other locks or connectors, but the adjustment knob system is most preferred because of its ease, safety, and simplicity. The tubing structure may be used for other purposes wherein a tarp, sheet, or panel is to be supported above an interior space that can house a person(s), plant(s), and/or other objects.

This application claims priority of Provisional Application Ser. No. 60/941,280, filed May 31, 2007, the entire disclosure of which is incorporated herein by this reference.

### BACKGROUND OF THE INVENTION

1. Field of the Invention

The present invention relates to an adjustable frame device that includes an invented effective and easy-to-use adjustment mechanism. The adjustable frame device may be used in conjunction with a conventional bed or in other settings, especially those in which a sheet, tarp, or other cover is to be held off of an underlying surface to create an interior space for a person, plants, or other equipment to occupy.

In bed cover support applications, the frame device may be supported by the box spring and mattress of the bed and is utilized to hold the bed covers above and away from a portion of the anatomy of the occupant of the bed. Use of the invented device will be recognized as extremely practical by those persons engaged in hospital or nursing home work, wherein it is at times desirable to elevate bed covers above the occupant of a bed, and especially above the feet or legs of the occupant of the bed to allow more freedom of movement and to encourage good skin health. The preferred embodiments are made entirely or substantially from off-the-shelf parts and are is adjustable in multiple directions, for convenient and versatile use as a support of bed covers or for other sheets or panels in a variety of environments.

The preferred embodiment is adapted to be disassembled in multiple ways to form multiple configurations for various purposes. For example, one disassembly method results in a compact configuration for longer-term storage, and another results in a lowered configuration for temporary storage from which it is easy to again set up the frame device for use.

2. Related Art

Many bed cover supports have been disclosed in the patent literature, including the following: U.S. Pat. No. 2,244,310 (Murphy); U.S. Pat. No. 2,291,203 (Bent); U.S. Pat. No. 3,317,932 (Gibbons, Sr.); U.S. Pat. No. 3,808,614 (Reinhard); U.S. Pat. No. 4,287,622 (Lane); U.S. Pat. No. 5,329,658 (Fontenot, et. al.); U.S. Pat. No. 6,834,403 B1 (Elliott); U.S. Pat. No. 7,137,159 B1 (Choate); and U.S. Patent Publication #US2005/0273931 A1 (Edwards).

Still, even in view of the many bed cover supports that have been designed, there is a need for a bed cover support device that is simple, durable, and easily adjustable and usable by a wide variety of people, businesses, and medical or care facilities. The inventor believes that there is a need for such a bed cover support device that may be made entirely or substantially of sturdy and safe off-the-shelf parts that are commercially available, so that the device may be made and repaired economically. There is still a need for an adjustable frame device that is easy to transform into a compact configuration and/or a lowered configuration for long-term or temporary storage. There is still a need for an adjustment mechanism, which may be used in such a frame device or in other frame devices, that is safe, easy, and quick to use, and that may be made from off-the-shelf parts.

### SUMMARY OF THE INVENTION

In a first set of embodiments, the invention comprises an adjustable frame device that is adapted to lift bed covers, a tarp, or other sheet or panel structure above an underlying surface, to create an interior space underneath said sheet or panel structure for receiving a person, a part of a person, plants, equipment, or other items that are to be warmed, protected, shielded, or otherwise covered by said sheet or panel structure. In alternative embodiments, the invention is an adjustment mechanism that allows adjustment of the frame in any direction along the length of an elongated frame portion or portions, wherein said elongated frame portion(s) each comprises two tubes that are coaxial and slidable relative to each other unless locked in place relative to each other by said adjustment system.

In preferred embodiments, the invented frame device is adapted to elevate and support portions of bed covers above the top surface of the bed mattress so that they may be raised above the occupant of the bed to minimize contact and/or pressure from said covers on regions of the occupant's body. The preferred frame device comprises two foot portions, which are inserted below a mattress, two leg portions that extend upward from the foot portions on each side of the mattress, and an upper support portion that extends transversely preferably all the way across the bed and upon which the covers are placed. Each leg portion may be formed of two telescoping leg members that are adjustably fixed together by the invented adjustment mechanism. There is no requirement for direct attachment of the frame device to the bed frame or to the box spring or mattress, but, instead, the feet of the device are temporarily trapped in-between the box spring and the mattress by means of being slid a significant distance in-between said box spring and mattress. There is no need for any fasteners from the feet to the box spring or to the mattress, and no need for connectors between the feet, especially no connectors that extend between the feet underneath the mattress.

Preferably, there is an adjustment in the transverse width of the frame device by means of telescoping or other adjustment of the upper support portion to be wider so that, preferably, it has the same width as the bed mattress. Preferably, there are adjustments in the overall height of the device by means of telescoping or other adjustment of the length (height) of the two leg portions. The device is portable, lightweight, and adjustable to fit various sizes of beds and occupants and to adjust for various preferences of the occupant and/or caregiver. The device may be easily assembled and placed into position upon a bed by a single individual without assistance. The device also may be easily disassembled by a single individual, without assistance, to configurations that include: a substantially or entirely disassembled configuration for cleaning and/or sanitizing of the individual parts; a partially disassembled configuration for temporary storage, such as a lowered configuration; and a partially disassembled configuration for transport and longer-term storage, such as a collapsed/folded configuration. The device may be made from plastic tubing and fittings that may be easily disassembled, cleaned and sanitized, and then reassembled, without damage to the materials.

The preferred device may be constructed from parts that are readily available “off the shelf” items and that are sturdy and very unlikely to be damaged or bent, and very unlikely to become difficult to adjust even after many uses and/or many adjustments. Preferred embodiments may comprise both vertical and horizontal adjustment systems wherein the device may be adapted to any size and shape of bed and/or support virtually any size and shape of sheet or panel.

The preferred device may be used in cooperation with equipment other than a bed or with sheets or panels other than bed covers. For example, embodiments may be used as a support for a tent, a hunting shelter, camouflage cover, mosquito netting, or other covers or shades.

### BRIEF DESCRIPTION OF THE DRAWINGS

FIG. 1 is a perspective view of one embodiment of the invented frame device, in a configuration for use, installed on a bed prior to being covered by bed covers.

FIG. 2 is a side elevation view of the embodiment of FIG. 1, in use with an occupant and bed covers.

FIG. 3 is a perspective view of the embodiment of FIGS. 1 and 2, wherein the two leg members of each leg portion are disconnected from each other to separate the upper support portion from the feet. This disconnection is done by unlocking the preferred adjustment system.

FIG. 4 is a perspective view of the embodiment of FIGS. 1-3, fully assembled in the “in-use” configuration.

FIG. 5 is a detail, partial perspective view of the preferred adjustment system of the embodiment of FIGS. 1-4, said adjustment system circled in FIG. 4.

FIG. 6 is an exploded perspective view of the adjustment system featured in FIG. 5.

FIG. 7 is a cross-sectional elevation view of the adjustment system featured in FIGS. 5 and 6.

FIG. 8 is a disassembled perspective view of an alternative embodiment of the invented frame device, which is the same as that in FIGS. 1-4 except for each of the upper leg members having an alternative end, that is, an end with improved hand grip features. Portions of the device are shown as separated and/or folded/collapsed for easy storage or transport. The upper and lower leg members of the right and left leg portions are unlocked and separated, with each lower leg member remaining attached to, and foldable against, its respective right or left foot. Further, the left, upper leg member is shown detached from said upper support portion, to indicate that said upper support portion may be stored without its leg members.

FIG. 9 is a disassembled perspective view according of the embodiment of FIGS. 1-4 and 8, wherein the upper leg members are disconnected from the upper support portion and inserted and locked into their respective lower leg members. This way, each entire leg portion (comprising upper and lower leg members) may be folded down against its respective foot.

FIG. 10A is a detail, close-up view of one foot portion combined with one leg portion illustrating that the upper leg member may be being slidable substantially all the way down into the lower leg member before locking the upper and lower leg members together, wherein that configuration will result in a very compact combined foot and leg unit for storage.

FIG. 10B is a detail, partial cross-section view of the upper end of the upper leg of FIGS. 8-10A, wherein there is shown in cross-section the handle sleeve provided around the upper end of the leg member.

FIG. 11 is a perspective view of the embodiment of FIGS. 1-4, in short-term storage on a bed, wherein the lower leg members have been detached from the foot portions and left connected and locked, by means of the adjustment system, to the upper leg members. This configuration, wherein the entire leg portions depend from the upper support portion, ensures that no members protrude up from the feet. This partially disassembled configuration lowers the upper support portion to be close to the top of the mattress, and the entire device is temporarily stored in a way that will be out of the way and safe for workers and adjacent patients.

FIG. 12 is a perspective view of the embodiment of FIGS. 1-4, illustrating the device used to support a tent or mosquito netting.

### DESCRIPTION OF THE PREFERRED EMBODIMENTS

Referring to the Figures, there are shown several, but not the only, embodiments of the invented frame device, which may be used to elevate and support bed covers (such as sheets, blankets, quilts, comforters, and/or coverlets) or tarps, nets, or other sheets or panels. The term “sheets or panels” is a broad term that includes flexible, semi-rigid, and rigid materials; hereafter and in the claims, the single word “cover” is used to include said sheets and panels including flexible, semi-rigid, and rigid materials.

The preferred frame device supports said bed covers above the desired portion of the anatomy of an occupant of the bed, or which may be used to support other panels, sheets, tents, netting, or other objects to create an interior space for receiving a part of a person, a person, plants, equipment or other objects.

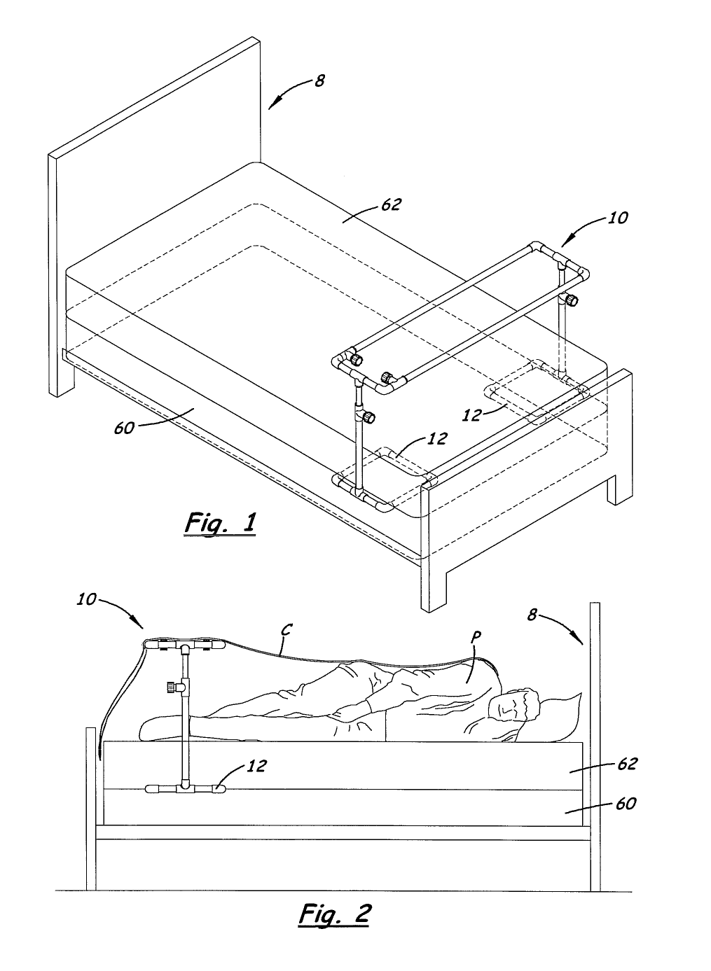

Referring now to FIG. 1, it will be observed that bed cover frame device 10 may be anchored to the bed for use, by placing portions of the frame device 10 between the box spring 60 and the mattress 62. The pedestals 12 (or “feet”) may be slid, from their respective sides of the bed, between box spring 60 and mattress 62 of bed 8. The pedestals 12 are preferably rectangular or square in “footprint” so that they are unlikely to tilt or pivot. The pedestals 12 are sized to extend a distance underneath the mattress 62 that, when combined with the substantial weight of the mattress 62, is sufficient to retain bed cover frame device 10 in the desired position upon the bed.

Referring now to FIG. 2, it will be observed that when a person P occupies bed 8 with the bed cover frame device 10 in place, bed covers C may be elevated above the desired portion of the anatomy of person P. Note that the frame device 10 is preferably near the foot end of the bed 8, but may be moved to nearly any position on the bed; the pedestals 12 may be slid underneath the mattress 62 at any place along the length of the mattress (or, for that matter, anywhere along the perimeter of the mattress), so that the frame device 10 may be shifted up and down along the length of the bed to suit the occupant (or, in rare instances even shifted to extend from the head to the foot of the mattress by being slide underneath the mattress at the head and the foot). Typically, the frame device 10 will be used to elevate the covers over the feet, to minimize pressure on the feet and to allow the occupant to easily move and shift his position (for example, to help eliminate “bed sores”), but there may be instances in which elevating and supporting other portions of the bed covers may be beneficial.

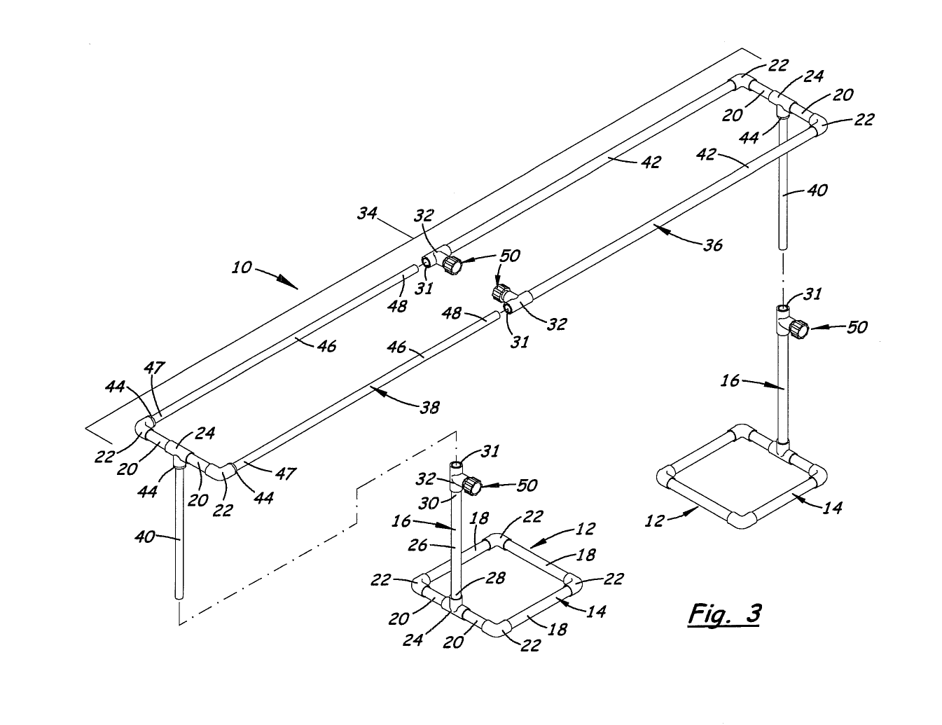

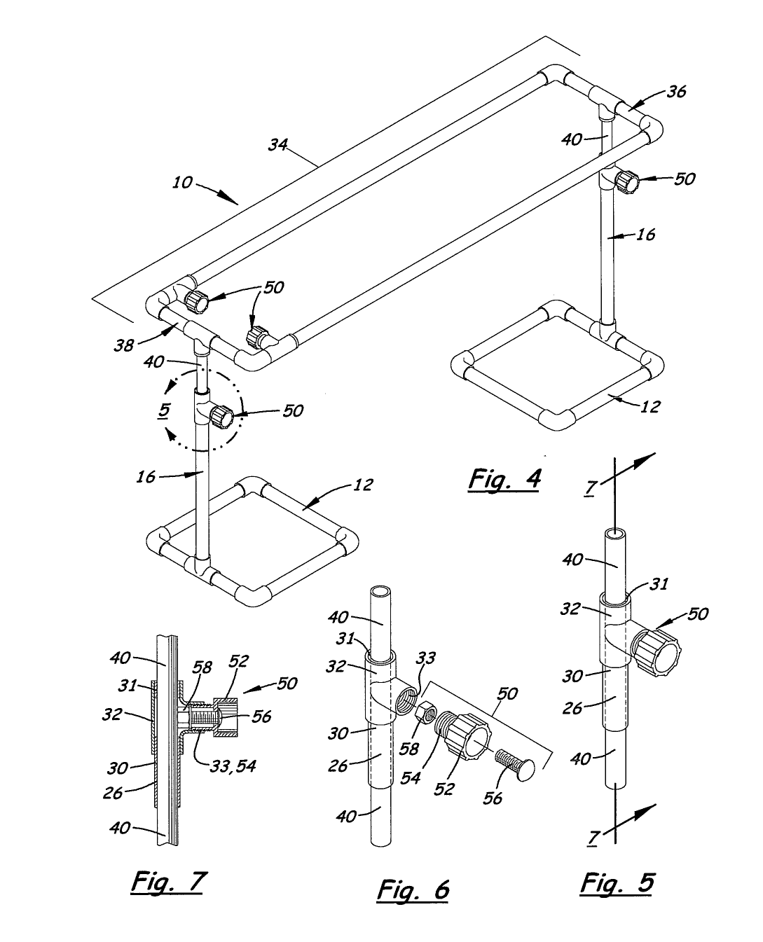

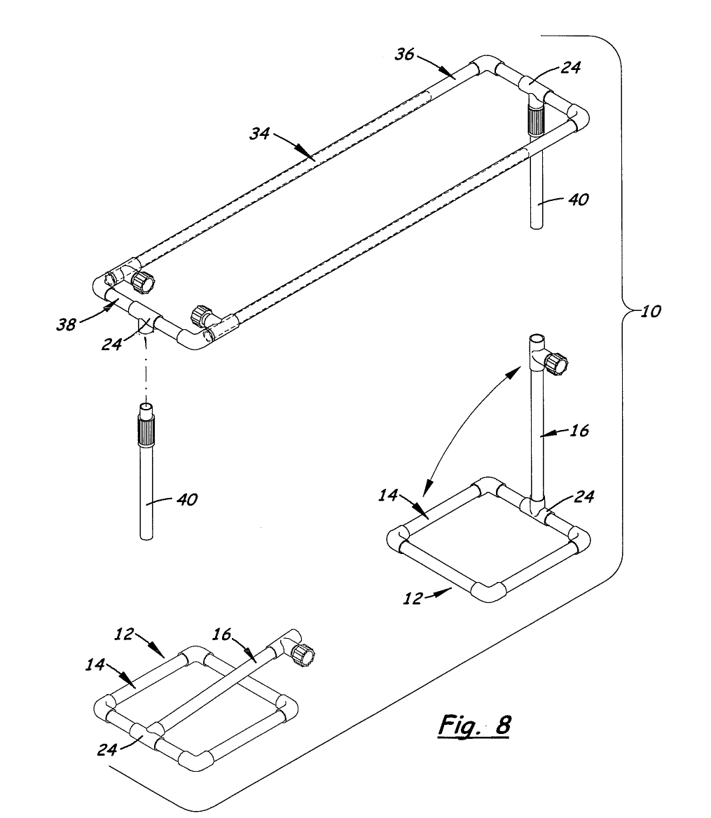

Referring now to FIGS. 3 and 4, it will be seen that the preferred bed cover frame device 10 is constructed of a plurality of plastic PVC pipe and fittings, which may be purchased off-the-shelf from PVC piping suppliers. The larger pipes are preferably ¾ inch inside diameter and the smaller pipes are preferably ½ inch inside diameter. At points where a rigid/fixed, permanent connection is desired, appropriate adhesive is used to join the pipes and fittings. At points where a non-permanent connection between pipes and/or fittings is desired (for example, so that disassembly such as in FIG. 8-11 may be done for lowering, folding, collapsing, transporting, or storing), tight but detachable friction fits are provided without adhesive. At points where it is desired that the smaller pipes be slideably mounted within the larger pipes (for a type of telescoping extendibility), bushings appropriately sized to the outside diameter of the smaller pipes are used; said bushings are rigidly mounted/fixed within the appropriate tee or elbow fittings to allow the smaller pipes to fit snugly but moveably within the larger pipes.

Bed cover frame device 10 is generally comprised of two lower pedestals (or “feet”) 12, two leg portions made of vertical stanchions 16 (or lower leg member) and posts 40 (upper leg portions), and upper support structure 34. Each of the pedestals 12 is generally comprised of a rectangular horizontal tubing structure 14. Horizontal tubing structure 14 is comprised of three tubes 18 of preferably equal length and two tubes 20 of equal length (but shorter than the length of tubes 18). The five aforementioned tubes are rigidly, adhesively affixed to one another using four elbows 22, for forming a square foot. In each pedestal structure 12, the tee 24 is mounted snugly upon tubes 20 as shown but is free to rotate upon tubes 20 to allow the pedestal 12 plus leg/leg members to be made as compact as possible when not in use. (See FIGS. 8, 9, and 10A). Vertical stanchion 16 is comprised of tube 26 adhesively affixed within tee 24 at its lower end 28 and affixed within tee 32 at its upper end 30. Within (and/or connected to) tee 32 resides adjustment system 50 (See FIGS. 5-7).

Upper support structure 34 is generally comprised of right and left tubing structures 36 and 38, which are examples of right and left U-shaped frames. Right and left tubing structures 36, 38 slideably or otherwise adjustably connect to each other to form a rectangular platform that is distanced from the upper surface of the mattress by the foot and leg portions of the device. These right and left tubing structures are adjustable horizontally in relation to one another, for increasing or decreasing the overall width of the device (the longest dimension of the upper structure 34 being called the “width” of the device because it is typically placed parallel to the width of the bed). The upper support structure 34 is generally flat and on a plane across which the bed covers are placed, so that the plane of the upper support structure 34 is parallel but distanced from the upper surface of the bed mattress. At each end of the upper support structure 34 is provided a vertical post 40, which become the upper leg members of the leg portions.

Tubing structure 36 is comprised of two ¾ inch tubes 42 and two ¾ inch tubes 20 rigidly, adhesively affixed to one another using elbows 22. Tee 24 is mounted and fixed to tubes 20, and post 40 (½ inch diameter) may be rigidly fixed within tee 24 utilizing bushing 44. Alternatively, the post 40 with its bushing 44 may be slideably removable from the tee 24, or the post 40 may be removable from bushing 44. Having the upper end of post 40 (with its bushing 44 or other upper end structure) be removable from the tee 24 (for example, see FIGS. 8-10A and B) allows post 40 to be removed from the upper support structure for disassembly and storage or transport. The lower end of post 40 is designed to be inserted within stanchion 16 (lower leg member) at the upper end of tee 32, wherein bushing 31, having an inside diameter sufficient to accept the outside diameter of post 40, is rigidly secured. Rigidly affixed at the inner ends of tubes 42 are tees 32 containing adjusting systems 50. (See FIGS. 5-7).

Tubing structure 38 (the tubing structure toward the left in FIG. 3) is, in effect, a mirror image of the right tubing structure 36 (except that the inner ends of tubes 46 cooperate with the adjusting system 50 fixed to right tubing structure tubes 42). Upper tubing structure 38 is comprised of two ½ inch tubes 46 and two ¾ inch tubes 20, rigidly and adhesively secured to one another using elbows 22 and bushings 44 at elbows 22 where end 47 of tubes 46 are joined. Vertical post 40 is mounted as described above for tubing structure 36, preferably by being slideably and removably inserted into tee 24. Ends 48 of tubes 46 slide through bushings 31 secured within tees 32 (of the adjustment system 50 of upper structure 34) and, hence, within tubes 42 of tubing structure 36.

FIG. 4 illustrates the preferred frame device to best advantage, as it is configured when ready for use after being adjusted in width to its minimum width.

Referring now to FIGS. 5, 6 and 7, adjustment system 50 is detailed, wherein said adjustment system 50 is preferably the same or similar in each of the locations on the frame device 10 where is it provided (that is, both for width adjustment and for height adjustment). Thus, ½ inch tubes 40 or 46 may be slideably adjusted and secured within ¾ inch tubes 26 or 42. Adjustment system 50 is preferably comprised of knob 52 comprising on one end a threaded portion 54 that mates with threads 33 within tee 32. Bolt 56 and nut 58 are secured within/on knob 52, via the bolt 56 extending through the knob 52 and the nut being threaded tightly onto the threaded end of the bolt to anchor/lock the bolt to/through the knob. When the nut is tightened to anchor/lock the bolt to/through the knob, the distal end of the bolt may protrude out beyond the distal end of the nut. The distal ends of the bolt and the nut are the ends that are facing generally toward the center of the tee. When knob 52 is threaded within tee 32, the distal end surface(s) of the nut 58 and/or of bolt 56 contact(s)/abut(s) against the outside diameter of the ½ inch tubes 40 or 46, wherein turning/screwing the assembly 50 farther into the tee 32 serves to force the nut and/or bolt distal end surfaces more forcefully against the tube 40/46, in a manner similar to a set screw, to firmly lock the adjustment system.

Note that, in FIG. 7, the distal end surface of the nut 58 is portrayed to be the member that abuts against the tube 40 to keep the tube 40 from sliding relative to tube 26. Alternatively, it may be more likely (depending on the bolt length relative to the knob axis length) that the bolt distal end surface (when the nut is tightened against the end surface of the threaded portion 54) is the surface that will abut against the tube to keep tube 40 from sliding relative to tube 26, tee 32, and bushings 31. In other words, the bolt distal end surface is expected, in many embodiments, to protrude beyond the distal end surface of the nut, and so, is expected to be the abutment surface for the adjustment system 50. This may be preferred as the substantially flat and broad distal end surface of the bolt may provide more and less damaging abutment surface for locking the tube 40 relative to tube 26, tee 32, and bushings 31. In yet other embodiments, both the bolt distal end surface and the nut distal end surface may be coplanar or substantially co-planar and may both be abutment surfaces that abut into the tube 40. In either configuration, the abutment member immovably connects tube 40 to 46 within tee 32 at the appropriately adjusted position, and the abutment member preferably does not gouge into the tube 40 or otherwise significantly mar the tube 40.

Because of the firm and sure abutment of the abutment surface against the tube, the system 50 holds the device firmed in each adjusted position, and may be considered a “lock” or “latch.” To change the width or length adjustment of the device, knob(s) 52 is/are loosened slightly, whereupon the bolt (and/or nut, as discussed above) move slightly away from tubes 40 or 46, freeing tubes 40/46 to be moved within tees 32 to a different position. When the desired position is attained, knob(s) 52 is/are tightened so that the bolt (or nut) end(s) again abut against tubes 40 or 46 to lock the tubes 40/46 in the newly-adjusted position. Adjustment system 50 allows continuous, rather than incremental, adjustment of the length of a frame piece that is made of two coaxial tubes that are slidable relative to each other along the co-axis.

Referring now to FIG. 8, it will be seen that portions of the bed cover frame device 10 may be separated, and/or portions may be rotated with respect to one another, to allow the structure to be made as compact as possible for storage or transport. Each of the stanchions 16 may be rotated downwardly relative to each respective foot/pedestal 12 by rotating tee 24 upon tubes 20.

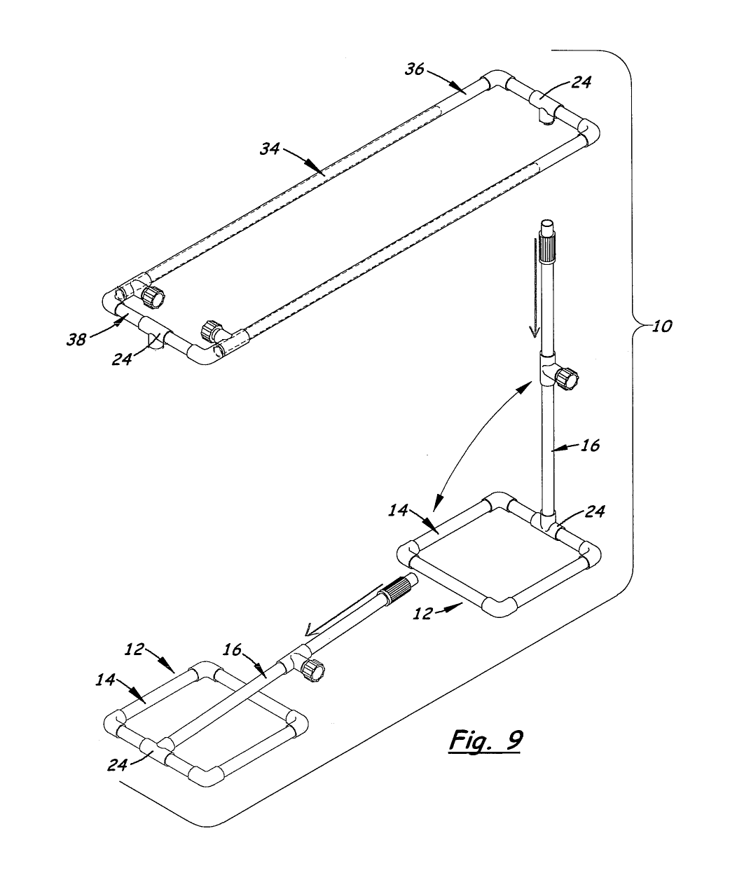

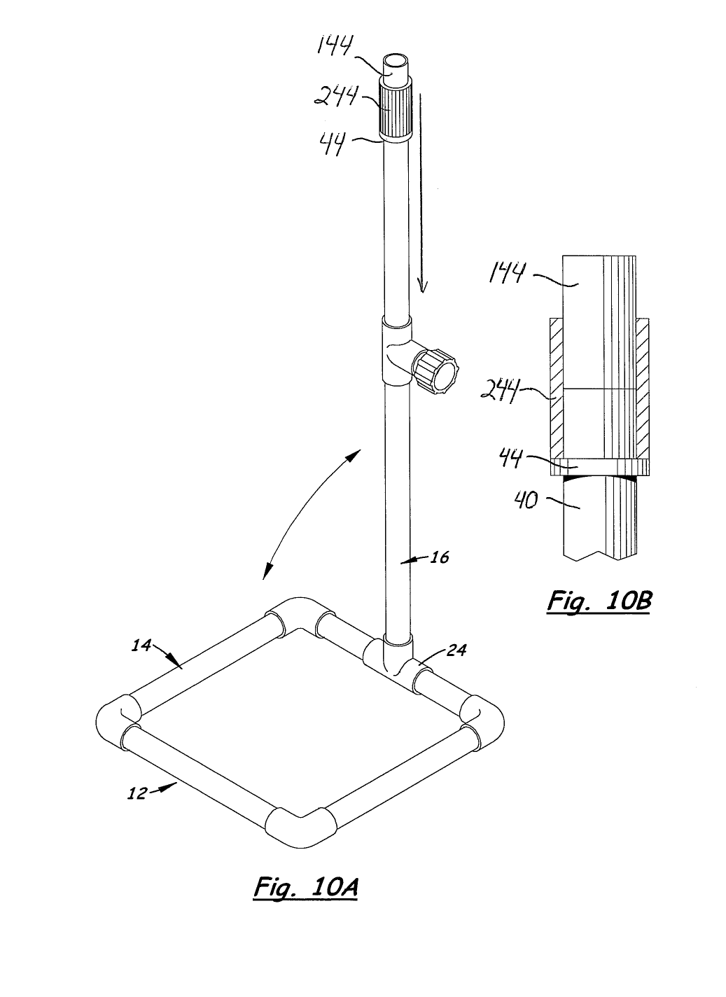

Further, as portrayed in FIGS. 8 and 9 to best advantage, the posts 40 (preferably with whatever bushing, sleeve, or other structure is provided on the upper end of post 40) may be removed from their respective tees 24. Thus, posts 40 could be removed from the upper structures 36, 38 and stored side-by-side with the other parts, or more preferably, stored inside the lower leg members (stanchions 16). The posts 40 may be slid into the stanchions, and locked in the stanchions by tightening the adjustment systems 50 on the stanchions 16. FIGS. 9 and 10A further illustrate the preferred storage configuration for the leg portions, wherein the posts 40 (upper leg members) are inside the stanchions 16 (lower leg members), and said posts may be slid substantially inside the stanchions. The upper ends of the posts 40 are enlarged compared to the rest of the post 40 structure, and so said upper ends will prevent the entire posts from sliding into the stanchions.

FIG. 10B illustrates in detail one alternative upper end for posts 40, wherein a short extension 144 protrudes as the uppermost end, and said extension 144 is attached to and held by sleeve 244 that surrounds the upper end of bushing 44. The short extension 144 slides into the tee 24 of the upper support structure 34, and the sleeve 244 provides a relatively large diameter handle for the user to grasp and rotate, if needed, to detach posts 40 from the upper support structure 34.

The methods of disassembling the frame device 10 shown in FIGS. 8-10A allow the device 10 to be transported and stored in a compact shape, wherein each foot and leg combination is separate from the upper, rectangular support structure 34, and the each foot and leg combination is folded to be quite flat, that is, to have the leg be generally co-planar with its respective foot.

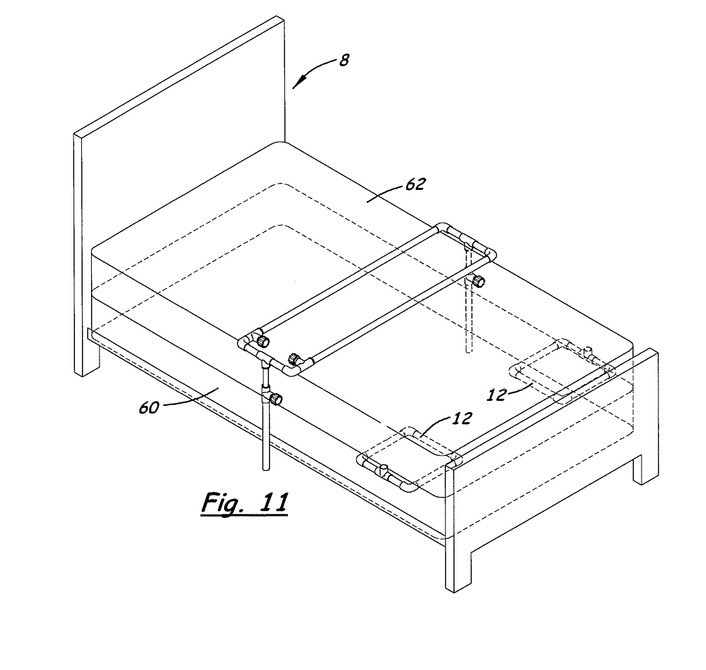

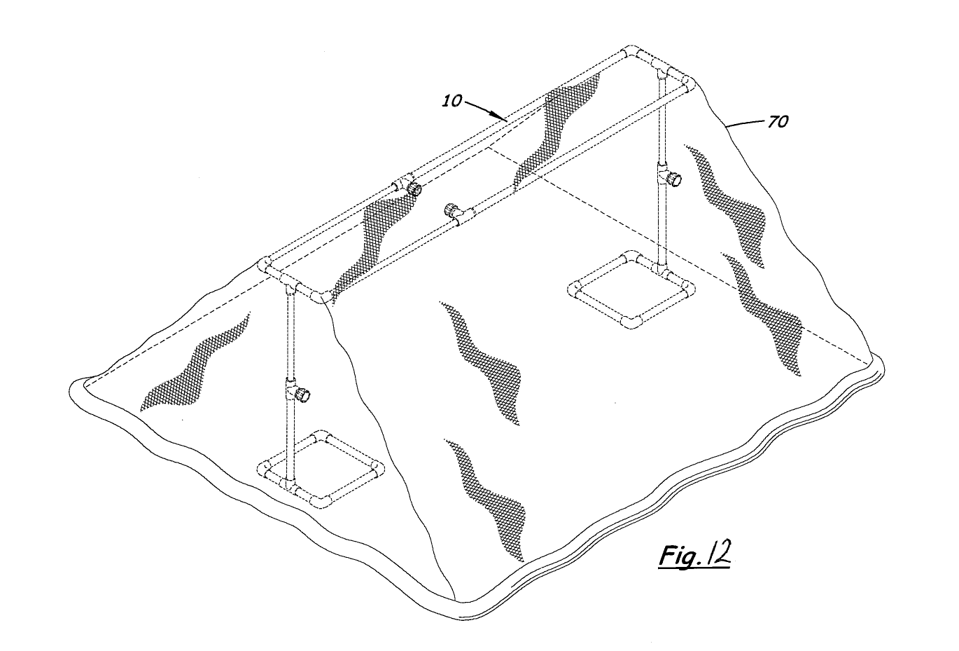

Referring now to FIG. 11, there is a shown a “lowered” configuration wherein the upper support structure 34 is lowered to the top of the bed by means of detachment of the leg portions (combined stanchion 16 and post 40) from the feet 12. By lowering the support structure 34 to the bed (with leg portions attached) and by leaving the feet 12 in between the springs and mattress, the entire device 10 is close to surfaces of the bed and not protruding upward to become a potential danger or an inconvenience when not in use. Also, by leaving the feet in between the springs and mattress, the stanchions 16 may be quickly reattached to the feet without lifting or moving the feet or the mattress, and the device 10 may be quickly placed in use again.

FIG. 12 illustrates an alternate environment in which the frame device 10 may be used, namely, to frame device a camping tent or mosquito net 70 for use in sleeping outdoors. The illustrated net 70 comprises a weighted perimeter edge to keep the net edge on the ground. Further, weights or other securement devices (not shown) might be used to stabilize the pedestals 12 on the ground in the event that the pedestals 12 are placed on the top surface of the ground.

The terminology of “horizontal” and “vertical” are not meant to necessarily be limiting, but are merely used for convenience to clarify preferred relationships of the parts of the device and preferred relationships of the device to the bed. Other orientations of the device to the bed or to other objects it holds may be included in the invention.

It may be noted that the tee, locking bolt, nut, and knob (herein also referred to as “the tee and lock,” for simplicity) of the adjustment system 50 is shown on particular ones of the U-shaped frames of the upper support structures (on the right U-shaped frame in FIG. 3), and on the lower leg members rather than the upper leg members. The tee and lock may be placed instead on the other U-shaped frames (the left U-shaped frame, in FIG. 3), or, less preferably, one tee and lock may be placed on each of the right and the left U-shaped frames. Likewise, the tee and lock may be placed on the upper leg members, rather than the lower leg members, or, less preferably, one tee and lock may be placed on each of the upper and lower leg members.

Alternative embodiments of the invention comprise the invented adjustment system 50 in other frame devices and/or on other elongated tubes. For example, one or more adjustment systems 50 may be used to slideably connect and lock many embodiments of coaxial tubes that are parts of simple or complex frame devices. Multiple adjustment systems 50 may be placed, as in the preferred embodiments, on both sides of a rectangular or otherwise-shaped frame to allow ends of the frame to be widened or lengthened. Or, individual tubes may be adjusted in length using the system 50. While the terms “tube” and “tubes” is used herein and in the claims, it may be noted that it is the outer member of the coaxial, slidable, adjustable connection that should be hollow to allow slidable insertion of the inner member. The inner member, while also described as a tube, may alternatively be solid. A solid inner member, however, may perhaps unnecessarily add to the weight of the frame, and so the inner member may also be described as a cylindrical inner member or an elongated inner member. Further, both outer and inner members may be other than cylindrical, for example, a square (in transverse cross-section) outer tube and a square (in transverse cross-section) inner member. In such embodiments, the abutment member distal surface of the adjustment system preferably abuts against a flat side of the inner member.

Although this invention has been described above with reference to particular means, materials and embodiments, it is to be understood that the invention is not limited to these disclosed particulars, but extends instead to all equivalents within the broad scope of the following claims.

1. A frame device for supporting at least one cover above an interior space, the frame device comprising:
an upper support structure comprising right and left U-shaped frames slideably and adjustably connected together by at least two frame adjustment systems;
right and left leg portions extending downward from said right and left U-shaped frames; and
a right foot and a left foot connected to said right and left leg portions, respectively;
wherein said right and left leg portions each comprise upper and lower leg members slideably and adjustably connected together by at least two leg adjustment systems;
wherein each of the feet is an open, rectangle frame;
wherein said two leg adjustment systems each comprise a three-opening tee fixed to one of the lower leg member and upper leg member at a first opening of the tee, wherein the other of the lower leg member and upper leg member slides through a second opening of said tee and into said one of the lower leg member and said upper leg member;
wherein each of said leg adjustment systems further comprises a bolt extending through a knob handle and into a third opening of the tee and abutting at its distal end against said other of the lower leg member and upper leg member, a nut threaded onto the distal end of the bolt to retain the bolt in the knob handle, and wherein the knob is threadably connected to the tee at said third opening; and
wherein the distal end of the bolt is generally flat.

2. A frame device as in claim 1, wherein said at least two frame adjustment systems each comprise a tee having a first opening fixed to one of the right and left U-shaped frames, and the other of the right and left U-shaped frames slides into a second opening of said tee and into said one of the right and left U-shaped frames; and
wherein each of said at least two frame adjustment systems further comprises a bolt extending through a knob handle and into a third opening of the tee and abutting at its distal end against said other of the right and left U-shaped frames, a nut threaded onto the distal end of the bolt to retain the bolt in the knob handle, wherein the distal end of the bolt is generally flat.

3. A frame device as in claim 1, wherein each foot is square.

4. A frame device as in claim 1, wherein each of said upper leg members is slideably detachable from its respective right and left U-shaped frame.

5. A frame device as in claim 1, wherein each of said lower leg members is slideably detachable from its respective foot.

6. A frame device as in claim 1, wherein each of said lower leg members is pivotal relative to its respective foot to move to be generally co-planar with its respective foot.

7. A frame device as in claim 1, in combination with a bed having a mattress and a box spring, each of the feet being located between said mattress and said box spring near opposite sides of the bed, wherein said leg portions extend up beside opposite sides of the bed and wherein said upper support structure extends across the bed a distance from the top of the mattress.

8. A frame device as in claim 4, in combination with a bed having a mattress and a box spring, each of the feet being located between said mattress and said box spring near opposite sides of the bed, wherein said leg portions extend up beside opposite sides of the bed and wherein said upper support structure extends across the bed a distance from the top of the mattress.

9. A frame device as in claim 5, in combination with abed having a mattress and a box spring, each of the feet being located between said mattress and said box spring near opposite sides of the bed, wherein said leg portions extend up beside opposite sides of the bed and wherein said upper support structure extends across the bed a distance from the top of the mattress.

10. A system for supporting at least one bed cover above a bed, the system comprising:
a bed with a box spring and a mattress; and
a frame device comprising:
an upper support structure comprising right and left frames slideably and adjustably connected together by at least two frame adjustment systems;
right and left leg portions extending downward from said right and left frames; and
a right and a left foot connected to said right and left leg portions, respectively;
wherein said right and left leg portions comprise upper and lower leg members slideably and adjustably connected together by at least two leg adjustment systems;
wherein said right foot and said left foot are placed between the mattress and the box spring on opposite sides of the bed, and wherein, when the frame device is in a first, in-use position, said leg portions extend up beside opposite sides of the bed and said upper support structure extends across the bed a distance from the top of the mattress for holding a bed cover; and
wherein said lower leg members are slideably detachable from the right and left feet, so that, when the frame device is in a second, storage position, the lower leg members are detached from the feet and the upper support structure combined with said leg portions is lowered until the upper support structure rests on the bed with said leg portions extending down along opposite sides of the bed.

11. A system as in claim 10, wherein said at least two frame adjustment systems each comprise a three-opening tee fixed at a first opening to one of said right and left frames, and the other of the right and left frames sliding through a second opening and into said one of the right and left frames;
wherein each of said at least two frame adjustment systems further comprises a threaded bolt extending through a knob handle and into a third opening of the tee and abutting at its distal end against said other of the right and left frames, and a nut threaded onto the distal end of the bolt to retain the bolt in the knob handle, wherein the distal end of the bolt is generally flat, and the adjustment system is adapted so that turning the knob in a first direction tightens the distal end against said other of the right and left frames.

12. A system of claim 10, wherein said two leg adjustment systems each comprise a three-opening tee fixed at a first opening to one of said lower leg member and upper leg member, and the other of said lower leg member and upper leg member sliding through a second opening of the tee and into said one of the lower leg member and upper leg member;
wherein each of said leg adjustment systems further comprises a bolt extending through a knob handle and into a third opening of the tee and abutting at its distal end against said other of said lower leg member and upper leg member, a nut threaded onto the distal end of the bolt to retain the bolt in the knob handle, wherein the distal end of the bolt is generally flat, and the adjustment system is adapted so that turning the knob in a first direction tightens the distal end against said other of the lower leg member and upper leg member.

13. A system as in claim 10, wherein said upper support structure is a rectangular frame that, when the frame device is in the first, in-use position and in the second, storage position, is parallel to the plane of the top of the mattress.

14. An adjustment system for slideably connecting an outer tube and an inner member coaxial with said outer tube, the system comprising:
an outer tube having an end, a three-opening tee fixedly attached to said end of the outer tube at a first of said openings;
an elongated, inner member slideably inserted into a second of said three tee openings and slideably extending into said outer tube and coaxial with said outer tube;
a threaded bolt extending through a handle knob and into a third opening of said three openings that is perpendicular to said first and second openings, wherein the handle knob is threadably connected to said third opening; and
a nut threaded onto the distal end of the bolt and retaining the bolt in the knob handle;
wherein, upon tightening the handle knob by rotating the handle knob, a distal end of said bolt abuts against said inner member to lock said inner member in any of many slidable locations inside the outer tube; and
wherein the distal end of the bolt is generally flat so that said distal end abuts into but does not gouge into said inner member.

15. An adjustment system as in claim 14, wherein all of said outer tube, said inner member, and said handle knob are PVC pipes and fittings.

16. An adjustment system as in claim 14, wherein said adjustment system provides continuous adjustment of the inner member relative to the outer tube.

17. An adjustment system as in claim 14, wherein an exterior surface of the handle knob is knurled.

18. An adjustment system as in claim 14, wherein said outer tube is cylindrical and said inner member is cylindrical.

19. An adjustment system as in claim 14, wherein said inner member is a hollow tube.

20. An adjustment system as in claim 14, wherein said nut has a distal end that is near said bolt distal end and also abuts into said inner member when the handle knob is tightened.
